(19) United States
(12) Patent Application Publication
(10) Pub. No.: US 2024/0272011 A1
(43) Pub. Date: Aug. 15, 2024

(54) Temperature Sensor

(71) Applicant: ROHM CO., LTD., KYOTO (JP)

(72) Inventor: Yoshito OTAGURO, KYOTO (JP)

(21) Appl. No.: 18/431,410

(22) Filed: Feb. 2, 2024

(30) Foreign Application Priority Data
Feb. 14, 2023 (JP) 2023-020834

(51) Int. Cl. G01K 7/01

(52) U.S. Cl. CPC G01K 7/01

(57) ABSTRACT

The present disclosure provides a temperature sensor. The temperature sensor includes: a temperature detection diode, disposed at a position having a target temperature and inserted into a target path between a first node and a second node; a current supply circuit, configured to supply first to third evaluation currents to the target path in a forward direction of the temperature detection diode at different timings; a voltage detection circuit, configured to detect a voltage between the first node and the second node when the first to third evaluation currents are respectively supplied to the target path as first to third evaluation voltages; and an arithmetic circuit, configured to detect the target temperature based on the first to third evaluation voltages.

### TECHNICAL FIELD

The present disclosure relates to a temperature sensor.

### BACKGROUND

Temperature sensors performing temperature detection by using PN junction diodes are extensively used.

### PRIOR ART DOCUMENT

### Patent Publication

[Patent document 1] Japan Patent Publication No. 2012-227517

### BRIEF DESCRIPTION OF THE DRAWINGS

FIG. 1 is a diagram of a current and a voltage associated with a diode according to the embodiment of the present disclosure.

FIG. 2 is a diagram of a current and a voltage associated with a diode according to the embodiment of the present disclosure.

FIG. 3 is a configuration diagram of a temperature sensor according to an embodiment of the present disclosure.

FIG. 4 is a diagram of a case where a path through which a forward current of a diode flows contains a resistive component in a temperature sensor according to an embodiment of the present disclosure.

FIG. 5 is a diagram of a case where a path through which a forward current of a diode flows contains a resistive component in a temperature sensor according to an embodiment of the present disclosure.

FIG. 6 is a flowchart of an overall operation of a temperature sensor according to a first embodiment of embodiments of the present disclosure.

FIG. 7 is a flowchart of a voltage detection process according to the first embodiment of the embodiments of the present disclosure.

FIG. 8 is a flowchart of a calculation process according to the first embodiment of the embodiments of the present disclosure.

FIG. 9 is a diagram of a relationship between a voltage and a temperature associated with detection according to the first embodiment of the embodiments of the present disclosure.

FIG. 10 is a diagram of a relationship between a digital value obtained by a calculation process and a temperature according to the first embodiment of the embodiments of the present disclosure.

FIG. 11 is a timing diagram associated with temperature detection according to the first embodiment of the embodiments of the present disclosure.

FIG. 12 is a flowchart of a voltage detection process according to a second embodiment of the embodiments of the present disclosure.

FIG. 13 is a flowchart of a calculation process according to the second embodiment of the embodiments of the present disclosure.

FIG. 14 is a diagram of a bipolar transistor forming a diode according to a fifth embodiment of the embodiments of the present disclosure.

FIG. 15 is a perspective diagram of the appearance of a semiconductor device assembled with a temperature sensor according to a seventh embodiment of the embodiments of the present disclosure.

### DETAILED DESCRIPTION OF THE EMBODIMENTS

Details of examples of the embodiments of the present invention are given with the accompanying drawings below. In the reference drawings, the same parts are denoted by the same numerals or symbols, and repeated description related to the same parts is in principle omitted. Moreover, in the present application, in order to keep the description simple, by means of recording numerals or symbols of reference information, signals, physical quantities, functional units, circuits, elements or parts, names of information, signals, physical quantities, functional units, circuits, elements or parts corresponding to the numerals or symbols are sometimes omitted or abbreviated.

Some terms and definitions of arrangements used in the description of the embodiments of the present disclosure are first explained below. The so-called “ground” refers to a reference conductive unit having a reference voltage of 0 V potential or the 0 V potential itself. The reference conductive unit may be a conductor formed of such as metal. The 0 V potential is sometimes referred to as a ground potential. In the embodiments of the present disclosure, a voltage expressed without a specifically configured reference represents a potential from a ground aspect.

MOSFET is an abbreviation of metal-oxide-semiconductor field-effect transistor. Unless otherwise specified, a MOSFET is understood as an enhanced MOSFET. Moreover, unless otherwise specified, any in MOSFET, it is considered that the back gate is shorted to the source.

More than one FET can be configured as any switch, two terminals of the switch are conducted when the switch is in an on state, and on the other hand, the two terminals of the switch are non-conducted when the switch is in an off state.

In the description below, for any transistor or switch, the on state and the off state are sometimes expressed simply as on and off. Moreover, for any transistor or switch, a period in which the transistor or the switch becomes in an on state is referred to an on period, and a period in which the transistor or the switch is changed to being in an off state is referred to as an off period.

A connection formed between multiple parts of a circuit, such as elements, wires and nodes that form a circuit, can be understood as an electrical connection unless otherwise specified.

Referring to FIG. 1, a temperature detection method using a diode temperature sensor is described below. A temperature to be detected (in other words, measured) by the temperature sensor is referred to as a target temperature.

A diode D1 is a diode formed by a PN junction of a semiconductor. The denotation “If”′ is used to represent a forward current of the diode D1. When the forward current If is supplied to the diode D1, the denotation “Vf” is used to represent a forward voltage generated in the diode D1. According to the Shockley diode equation, formula (A1) below holds true.

$$V f = ( \frac{{K}_{B}}{q} ) \times {T}_{D} \times ln ( \frac{If}{Is} ) \qquad ( A1 )$$

Herein, K_{B} represents Boltzmann constant, and q represents an amount of charge of electrons. Thus, (K_{B}/q) has a fixed value. T_{D} represents a temperature of the diode D1 (a temperature that the diode D1 has). The diode D1 is disposed at a position having the target temperature. Thus, the temperature T_{D} is equal to the target temperature. The denotation “Is” is used to represent a saturation current of the diode D1. Moreover, in the formulae show in the present application, In(x) represents a natural logarithm of x. Thus, for example, In(If/Is) in formula (A1) represents the natural logarithm of (If/Is).

The saturation current Is has a constant value determined basically depending on the type of the diode D1. Thus, the temperature T_{D} (that is, the target temperature) can be detected by detecting the forward voltage Vf when the known forward current If is supplied to the diode D1.

However, the saturation current Is may be deviated due to manufacturing errors of the diode D1. Considering the above, a reference method for detecting voltages Vf1 and Vf2 satisfying formulae (A2) and (A3) below and obtaining a voltage ΔVf based on the voltages Vf1 and Vf2 according to formula (A4) is discussed.

$$V f 1 = ( \frac{{K}_{B}}{q} ) \times {T}_{D} \times ln ( \frac{If 1}{Is} ) \qquad ( A2 )$$

$$V f 2 = ( \frac{{K}_{B}}{q} ) \times {T}_{D} \times ln ( \frac{If 2}{Is} ) \qquad ( A3 )$$

$$Δ V f = V f 1 - V f 2 = ( \frac{{K}_{B}}{q} ) \times {T}_{D} \times ln ( \frac{If 1}{If 2} ) \qquad ( A4 )$$

The currents If1 and If2 represent forward currents If different from each other. The voltage Vf1 is a forward voltage Vf generated in the diode D1 by supplying the forward current If that satisfies “If=If1” to the diode D1. The voltage Vf2 is a forward voltage Vf generated in the diode D1 by supplying the forward current If that satisfies “If=If2” to the diode D1.

Formula (A4) is independent from the saturation current Is. Thus, by calculating the voltage ΔVf according to a difference between the voltages Vf1 and Vf2 and performing a calculation according to formula (A4), the temperature T_{D} can be obtained without influences of the deviation in the saturation current Is.

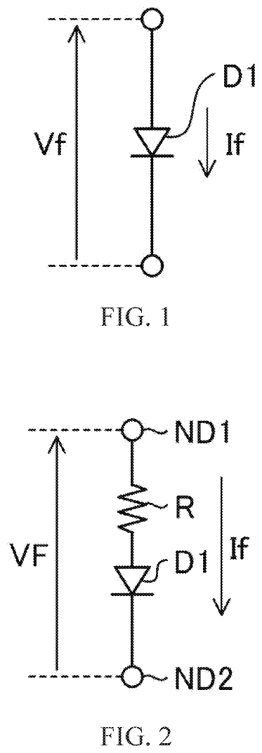

However, in the temperature sensor, as shown in FIG. 2, there is a case where the resistance component R is connected in series to the diode D1, and the voltage VF generated by the series circuit of the diode D1 and the resistance component R is measured in practice in order to detect the target temperature. In the circuit in FIG. 2, a node ND1 is connected to an anode of the diode D1 via the resistive component R, and a cathode of the diode D1 is connected to a node ND2. A potential at the node ND1 viewed from a potential at the node ND2 is the voltage VF. The resistive component R can be a parasitic resistance of a wiring generated when the temperature sensor is formed. Alternatively, a resistor formed by an electrostatic discharge (ESD) protection resistor or a filter can be equivalent to the resistive component R.

In the circuit in FIG. 2, when the current If1 is supplied to the diode D1 as the forward current If, the voltage VF is consistent with the voltage VF1 of formula (B1); when the current If2 is supplied to the diode D1 as the forward current If, the voltage VF is consistent with the voltage VF2 of formula (B2). R in formula (B1) and formula (B2) also represents a resistance value of the resistive component R (the same applies to formula (B3) and formula (B4) below).

$$V F 1 = ( \frac{{K}_{B}}{q} ) \times {T}_{D} \times ln ( \frac{If 1}{Is} ) + R \times If 1 \qquad ( B1 )$$

$$V F 2 = ( \frac{{K}_{B}}{q} ) \times {T}_{D} \times ln ( \frac{If 2}{Is} ) + R \times If 2 \qquad ( B2 )$$

A current If3 is used to eliminate the term of the resistive component R. The currents If1 to If3 have current values different from one another. In the circuit in FIG. 2, when the current If3 is supplied to the diode D1 as the forward current If, the voltage VF is consistent with a voltage VF3 in formula (B3). By setting both sides of formula (B3) to two times, formula (B4) can be obtained.

$$V F 3 = ( \frac{{K}_{B}}{q} ) \times {T}_{D} \times ln ( \frac{If 3}{Is} ) + R \times If 3 \qquad ( B3 )$$

$$2 \times V F 3 = ( \frac{{K}_{B}}{q} ) \times {T}_{D} \times ln ( \frac{If {3}^{2}}{{Is}^{2}} ) + 2 \times R \times If 3 \qquad ( B4 )$$

Herein, it is assumed that the formula (B5) holds true. Under the assumption above, when the voltage ΔVF is defined to satisfy formula (B6), the saturation current Is and the resistive component R can be eliminated from the right of formula (B6). That is to say, formula (B7) can be obtained when formula (B6) is transformed using formulae (B1) to (B5).

$$2 \times If 3 = 1 \times If 1 + 1 \times If 2 \qquad ( B5 )$$

$$ΔV F = 2 \times V F 3 - ( 1 \times V F 1 + 1 \times V F 2 ) \qquad ( B6 )$$

$$ΔV F = ( \frac{{K}_{B}}{q} ) \times {T}_{D} \times ln ( \frac{If {3}^{2}}{If 1 \times If 2} ) \qquad ( B7 )$$

Thus, after the voltages VF1, VF2 and VF3 are detected, the value of the voltage ΔVF can be derived according to formula (B6), and the temperature T_{D} can be obtained using a derived result according to formula (B7). Formula (B7) does not include the saturation Is term and does not include the resistive component R term. Thus, the temperature T_{D} obtained according to formula (B7) does not receive influences of the deviation in the saturation current Is, and does not receive influences of the resistive component R. That is to say, high-precision temperature detection from which the influences above are eliminated can be performed.

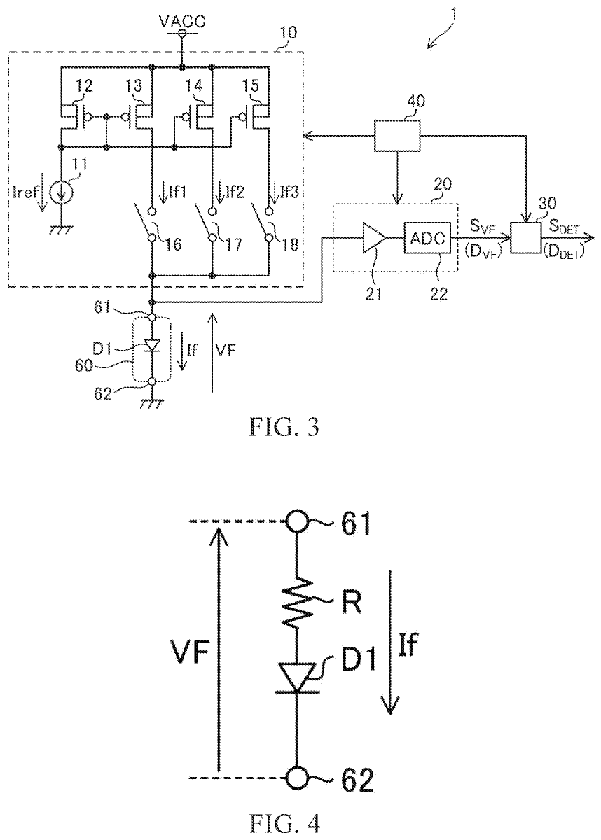

FIG. 3 shows a configuration diagram of a temperature sensor 1 according to this embodiment of the present disclosure. The temperature sensor 1 can be formed by a semiconductor integrated circuit. The temperature sensor 1 includes a diode D1 as a temperature detection diode, and uses the diode D1 to detect (in other words, measure) the target temperature. As described above, the diode D1 is disposed at a position having the target temperature. Thus, the temperature T_{D} is equal to the target temperature.

In the temperature sensor 1, a current path between nodes 61 and 62 is referred to as a target path 60. The diode D1 is inserted into the target path 60. The node 61 is equivalent to the node ND1, and the node 62 is equivalent to the node ND2. In the temperature sensor 1, the current If is a current flowing from the node 61 to the node 62 through the diode D1 (that is, a forward current of the diode D1). However, according to timings, “If=0”. When “If>0”, the current If flows in a forward direction of the diode D1. In the temperature sensor 1, the voltage VF refers to a potential at the node 61 viewed from a potential at the node 62, that is, a voltage (a potential difference) between the nodes 61 and 62 by using the potential at the node 62 as a reference. In the temperature sensor 1, the node 62 is connected to ground. Thus, the voltage VF is a voltage at the node 61 viewed from a ground potential.

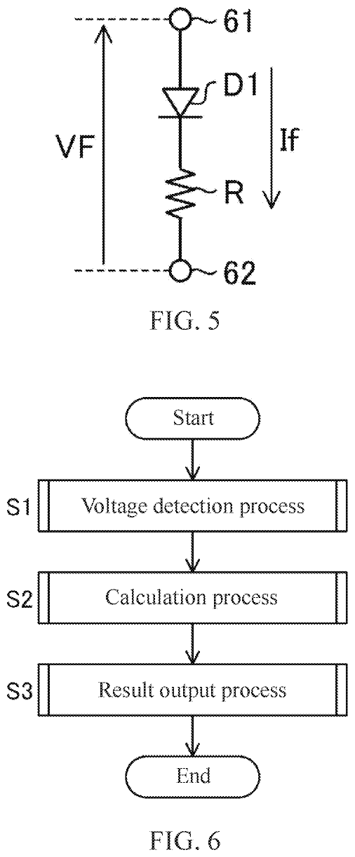

Although not shown in FIG. 3, the resistive component R similarly exists between the nodes 61 and 62. For example, similar to the circuit shown in FIG. 2, as shown in FIG. 4, the resistive component R exists between the node 61 and the anode of the diode D1, and the cathode of the diode D1 is directly connected to the node 62. Alternatively, as shown in FIG. 5, the resistive component R is between the cathode of the diode D1 and the node 62, and the anode of the diode D1 is directly connected to the node 61. There can be a case where a first resistive component is between the node 61 and the anode of the diode D1, and a second resistive component is between the node 62 and the cathode of the diode D1.

The temperature sensor 1 includes a current supply circuit 10, a voltage detection circuit 20, an arithmetic circuit 30 and a control circuit 40.

The current supply circuit 10 supplies first to third evaluation currents to the target path 60 at different timings. Each of the first to third evaluation currents is supplied in a forward direction of the diode D1. The denotation “If1” is used as a reference to refer the first evaluation current as an evaluation current If1. Similarly, the denotation “If2” is used as a reference to refer the second evaluation current as an evaluation current If2. Similarly, the denotation “If3” is used as a reference to refer the third evaluation current as an evaluation current If3. The evaluation currents If1 and If3 have current values different from one another. When the evaluation currents If1, If2 and If3 are supplied to the diode D1, each of the evaluation currents If1, If2 and If3 is a forward current If of the diode D1. However, in the temperature sensor 1, the forward current If also passes through the resistive component R (referring to FIG. 4 to FIG. 5).

The current supply circuit 10 includes a constant current source 11, transistors 12 to 15, and switches 16 to 18. The transistor 12 to 15 are P-channel MOSFETs. A source of each of the transistors 12 to 15 is connected to a terminal to which a power supply voltage VACC is applied. The power supply voltage VACC has a predetermined positive DC voltage value. A gate and a drain of the transistor 12 are commonly connected to respective gates of the transistor 13 to 15. The constant current source 11 is disposed between the drain of the transistor 12 and the ground. A drain of the transistor 13 is connected to a first end of the switch 16, a drain of the transistor 14 is connected to a first end of the switch 17, and a drain of the transistor 15 is connected to a first end of the switch 18. Respective second ends of the switches 16 to 18 are commonly connected to the node 61.

The constant current source 11 generates a reference current Iref flowing from the drain of the transistor 12 to the ground. Thus, a drain current of the transistor 12 is the reference current Iref. The reference current Iref has a predetermined current value. The transistors 12 to 15 form a current mirror circuit. Thus, a drain current proportional to the reference current Iref flows through each of the transistors 13 to 15. The drain current of the transistor 13 is the evaluation current If1, the drain current of the transistor 14 is the evaluation current If2, and the drain current of the transistor 15 is the evaluation current If3.

However, if the flow of an instantaneous current is overlooked, the drain current of the transistor 13 is generated only when the switch 16 is on, the drain current of the transistor 14 is generated only when the switch 17 is on, and the drain current of the transistor 15 is generated only when the switch 18 is on. Only any one among the switches 16 to 18 is controlled to be on, or all of the switches 16 to 18 are controlled to be off by the control circuit 40.

During an on period of the switch 16, “If=If1”. The condition “If=If1” means that the evaluation current If1 flows through the target path 60 as the forward current If of the diode D1. During an on period of the switch 17, “If=If2”. The condition “If=If2” means that the evaluation current If2 flows through the target path 60 as the forward current If of the diode D1. During an on period of the switch 18, “If=If3”. The condition “If=If3” means that the evaluation current If3 flows through the target path 60 as the forward current If of the diode D1.

The voltage detection circuit 20 includes a buffer amplifier 21, and an analog-to-digital converter (ADC) 22. The buffer amplifier 21 is connected to the node 61. The buffer amplifier 21 receives the voltage VF of the node 61 by a sufficiently high impedance, and outputs a voltage corresponding to the voltage VF of the node 61 by a sufficiently low impedance. Herein, the buffer amplifier 21 is set to be a voltage follower, and thus an output voltage of the buffer amplifier 21 has a voltage value equal to that of the voltage VF. However, the voltage VF can be amplified by an amplification factor of greater than 1 by the buffer amplifier 21, and the amplified voltage is output from the buffer amplifier 21.

The ADC 22 receives the voltage output from the buffer amplifier 21 as an input analog voltage thereof, and analog-to-digital (AD) converts the input analog voltage. In the AD converting, the ADC 22 samples the input analog voltage at a timing specified by the control circuit 40, and converts the sampled input analog voltage into a digital signal. The ADC 22 outputs a digital signal S_{VF} obtained from the AD converting. The digital signal S_{VF} has a digital value D_{VF} equivalent to a value of the sampled input analog voltage.

As such, the voltage detection circuit 20 has functions of detecting the voltage VF and outputting a detection result of the voltage VF as the digital signal S_{VF}. A detected value of the voltage VF is represented by the digital value D_{VF} which is the value of the digital signal S_{VF}. The digital value D_{VF} increases as the voltage VF increases (that is, as the detected value of the voltage VF increases). The digital signal S_{VF} is input to the arithmetic circuit 30.

The arithmetic circuit 30 performs a predetermined calculation process based on the digital signal S_{VF} obtained from multiple times of AD converting performed by the ADC 22, and accordingly detects the target temperature. The arithmetic circuit 30 generates and outputs a temperature detection signal S_{DET} indicating a detection result of the target temperature. The detection of the target temperature can be understood as to have the same significance as that of the generation or output of the temperature detection signal S_{DET}. The arithmetic circuit 30 can be implemented by a logic circuit capable of performing the calculation process. The temperature detection signal S_{DET} is a digital signal. The denotation “D_{DET}” is used to represent a digital value of the temperature detection signal S_{DET}. The digital value D_{DET} represents a detected value of the target temperature. Moreover, a modification of setting the temperature detection signal S_{DET} as an analog signal can also be carried out.

The control circuit 40 individually controls on and off of the switches 16 to 18. Moreover, the control circuit 40 perform control of an execution timing of the AD converting performed by the ADC 22. The control of the execution timing of the AD converting includes timing control of sampling in the ADC 22. Further, the control circuit 40 performs execution control of the calculation process using the arithmetic circuit 30.

In the multiple embodiments below, several specific operation examples, application techniques and variation techniques related to the temperature sensor 1 are described. Unless otherwise specified and without any contradiction, the items enumerated in this embodiment are applicable to the various embodiments examples below. In the various embodiments, the description of the embodiments can be considered as overruling in case of any items contradictory from the items described above. Provided there are not contradictions, the items described in any one of the embodiments below are also applicable to any other embodiment (that is to say, any two or more of the embodiments can be combined).

### First Embodiment

The first embodiment is described. In the first embodiment, it is assumed that the evaluation currents If1, If2 and If3 are respectively 140 μA, 5 μA and 32 μA. In this case, formula (C1) holds true. At this point, a voltage ΔV can be defined as formula (C2) below. VF1 represents the voltage VF when the evaluation current If1 is supplied to the diode D1 in FIG. 3 as the forward current If. VF2 represents the voltage VF when the evaluation current If2 is supplied to the diode D1 in FIG. 3 as the forward current If. VF3 represents the voltage VF when the evaluation current If3 is supplied to the diode D1 in FIG. 3 as the forward current If.

$$5 \times If 3 = 1 \times If 1 + 4 \times If 2 \qquad ( C1 )$$

$$ΔV F = 5 \times V F 3 - ( 1 \times V F 1 + 4 \times V F 2 ) \qquad ( C2 )$$

That is to say, formula (C3) can be obtained when formula (C2) is transformed using formulae (B1), (B2) and (B3). By setting both sides of formula (C3) to 4 times, formula (C4) can be obtained.

$$ΔV F = ( \frac{{K}_{B}}{q} ) \times {T}_{D} \times ln ( \frac{If {3}^{5}}{If {1}^{1} \times If {2}^{4}} ) \qquad ( C3 )$$

$$4 \times ΔV F = 4 \times ( \frac{{K}_{B}}{q} ) \times {T}_{D} \times ln ( \frac{If {3}^{5}}{If {1}^{1} \times If {2}^{4}} ) \qquad ( C4 )$$

Thus, after the voltages VF1, VF2 and VF3 are detected, the value of the voltage ΔVF can be derived according to formula (C2), and the temperature T_{D} can be obtained using a derived result according to formula (C3). Formula (C3) does not include the term of the saturation current Is or the term of the resistive component R. Thus, the temperature T_{D} obtained according to formula (C3) does not receive influences of the deviation in the saturation current Is, and does not receive influences of the resistive component R. That is to say, high-precision temperature detection from which the influences above are eliminated can be performed. In practice, the voltages VF1, VF2 and VF3 can be detected by the voltage detection circuit 20 (that is, a digital value of each of the voltages VF1, VF2 and VF3 can be obtained), and the calculation of formula (C2) is performed on the detected values of the voltage detection circuit 20 by the arithmetic circuit 30 to obtain a voltage ΔVF. The temperature T_{D} equivalent to the target temperature can be obtained based on the obtained voltage ΔVF according to formula (C3) by the arithmetic circuit 30. However, the derivation of the target temperature T_{D} using formula (C3) is not necessarily performed by the arithmetic circuit 30. Moreover, the voltage ΔVF is sometimes referred to as an arithmetic voltage below.

FIG. 6 shows a flowchart of an overall operation of the temperature sensor 1. After performing the voltage detection process of step S1, the temperature sensor 1 detects the target temperature by performing a calculation process of step S2. However, the calculation process of step S2 can also be started during execution of the voltage detection process of step S1. The voltage detection process is performed by the current supply circuit 10 and the voltage detection circuit 20 under the control of the control circuit 40. The calculation process is performed by the arithmetic circuit 30. A result output process of step S3 is performed after the calculation process of step S2. In the result output process, a calculation result of the calculation process of step S2 is output from the arithmetic circuit 30, as the temperature detection signal S_{DET}.

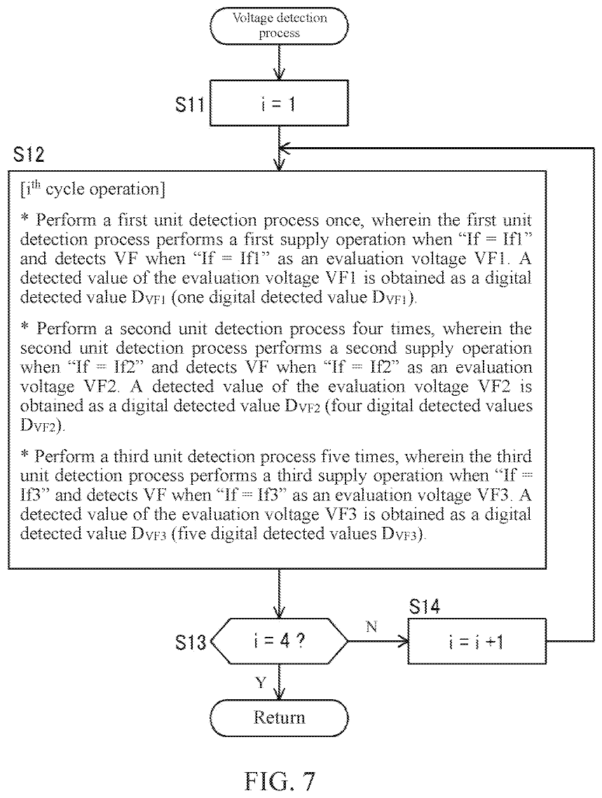

FIG. 7 shows a flowchart of the voltage detection process according to the first embodiment of the embodiments of the present disclosure. In the first embodiment, the voltage detection process of step S1 in FIG. 6 includes processes of step S11 to S14. In the voltage detection process, 1 is substituted into a variable i managed by the control circuit 40 itself in step S11. Step S12 is then performed.

In step S12, the temperature sensor 1 performs an i^{th} round of a cycle operation. In one round of cycle operation, the temperature sensor 1 performs a first unit detection process once, performs a second unit detection process four times, and performs a third unit detection process five times. The cycle operation is performed by the current supply circuit 10 and the voltage detection circuit 20 under the control of the control circuit 40.

The first unit detection process is a process of detection using the voltage Vf when “If=If1” as the evaluation voltage VF1. The first unit detection process includes a first supply operation. In the first supply operation, the control circuit 40 sets only the switch 16 among the switches 16 to 18 to be on. Accordingly, in the first supply operation, the evaluation current If1 supplied to the diode D1 by the current supply circuit 10 is used as the forward current If. In the first unit detection process, the control circuit 40 detects the evaluation voltage VF1 which is the voltage VF by the voltage detection circuit 20 while the evaluation current If1 is supplied to the diode D1 as the forward current If. The digital value D_{VF} representing a detected value of the evaluation voltage VF1 is obtained by detecting the evaluation voltage VF1 by the voltage detection circuit 20. The digital value D_{VF} representing the detected value of the evaluation voltage VF1 is specifically referred to as a digital detected value D_{VF1}. One digital detected value D_{VF1} is obtained from the first unit detection process performed once. Thus, one digital detected value D_{VF1} is obtained in one round of cycle operation.

The second unit detection process is a process of detection using the voltage Vf when “If=If2” as the evaluation voltage VF2. The second unit detection process includes a second supply operation. In the second supply operation, the control circuit 40 sets only the switch 17 among the switches 16 to 18 to be on. Accordingly, in the second supply operation, the evaluation current If2 supplied to the diode D1 by the current supply circuit 10 is used as the forward current If. In the second unit detection process, the control circuit 40 detects the evaluation voltage VF2 which is the voltage VF by the voltage detection circuit 20 while the evaluation current If2 is supplied to the diode D1 as the forward current If. The digital value D_{VF} representing a detected value of the evaluation voltage VF2 is obtained by detecting the evaluation voltage VF2 by the voltage detection circuit 20. The digital value D_{VF} representing the detected value of the evaluation voltage VF2 is specifically referred to as a digital detected value D_{VF2}. One digital detected value D_{VF2} is obtained from the second unit detection process performed once. Thus, four digital detected values D_{VF2} are obtained in one round of cycle operation.

The third unit detection process is a process of detection using the voltage Vf when “If=If3” as the evaluation voltage VF3. The third unit detection process includes a third supply operation. In the third supply operation, the control circuit 40 sets only the switch 18 among the switches 16 to 18 to be on. Accordingly, in the third supply operation, the evaluation current If3 supplied to the diode D1 by the current supply circuit 10 is used as the forward current If. In the third unit detection process, the control circuit 40 detects the evaluation voltage VF3 which is the voltage VF by the voltage detection circuit 20 while the evaluation current If3 is supplied to the diode D1 as the forward current If. The digital value D_{VF} representing a detected value of the evaluation voltage VF3 is obtained by detecting the evaluation voltage VF3 by the voltage detection circuit 20. The digital value D_{VF} representing the detected value of the evaluation voltage VF3 is specifically referred to as a digital detected value D_{VF3}. One digital detected value D_{VF3} is obtained from the third unit detection process performed once. Thus, five digital detected values D_{VF3} are obtained in one round of cycle operation.

Step S13 is performed after step S12. In step S13, the control circuit 40 determines whether “i=4” holds true. When “i=4” holds true (“Yes” of step S13), the voltage detection process ends. When “i=4” does not hold true (“No” of step S13), 1 is added to the variable i by the control circuit 40 in step S14, and step S12 is iterated. Upon iterating step S12, the cycle operation is again performed. Thus, in a phase when the voltage detection process in FIG. 7 ends, the cycle operation of step S12 has been performed four times.

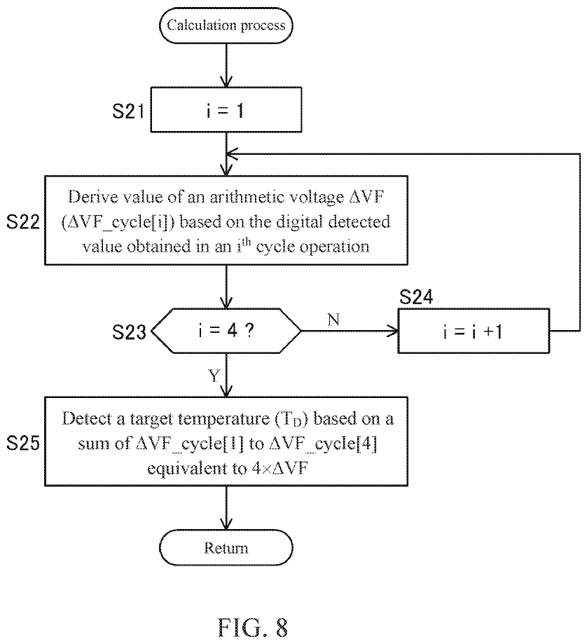

FIG. 8 shows a flowchart of the calculation process according to the first embodiment. In the first embodiment, the calculation process of step S2 in FIG. 6 includes processes of step S21 to S25. In the calculation process, 1 is substituted to a variable i managed by the arithmetic circuit 30 itself in step S21. Step S22 is then performed.

The process of step S22 is performed at any timing as desired after an i^{th} round of cycle operation ends. In step S22, the arithmetic circuit 30 derives the value of the arithmetic voltage ΔVF based on the digital detected value obtained in the i^{th} round of cycle operation according to formula (C2). With respect to the i^{th} round of cycle operation, the denotation “ΔVF_cycle[i]” represents the value of the arithmetic voltage ΔVF derived in step S21.

The digital detected value obtained in the i^{th} round of cycle operation includes one digital detected value D_{VF1}, four digital detected values D_{VF2}, and five digital detected values D_{VF3}. Thus, with respect to the i^{th} round of cycle operation, the one digital detected value D_{VF1} is substituted into the term (1×VF1) of formula (C2), a sum of the four digital detected values D_{VF2} is substituted into the term (4×VF2) of formula (C2), and five digital detected values D_{VF3} are substituted into the term (5×VF3) of formula (C2) to calculate the value on the left of formula (C2), and the value on the left calculated is set to be the value ΔVF_cycle[i].

Step S23 is performed after step S22. In step S23, the arithmetic circuit 30 determines whether “i=4” holds true. When “i=4” holds true (“Yes” of step S23), step S25 is performed. When “i=4” does not hold true (“No” of step S23), 1 is added to the variable i by the arithmetic circuit 30 in step S24, and step S22 is iterated. Upon iterating step S22, the process of step S22 is again performed. Thus, in a phase entering step S25, the values ΔVF_cycle[1] to ΔVF_cycle[4] have been derived.

In step S25, the arithmetic circuit 30 calculates a sum of the values ΔVF_cycle[1] to ΔVF_cycle[4]. The sum of the values ΔVF_cycle[1] to ΔVF_cycle[4] is equal to a voltage (4×ΔVF). Thus, in step S25, the arithmetic circuit 30 substitutes the sum of the values ΔVF_cycle[1] to ΔVF_cycle[4] to the left of formula (C4) to solve formula (C4) for the temperature T_{D}, accordingly detecting the target temperature (that is, the temperature T_{D}). With respect to the temperature sensor 1 (the arithmetic circuit 30), the values of the evaluation currents If1, If2 and If3, the Boltzmann constant K_{B}, and an amount of charge q of electrons are known.

In the arithmetic circuit 30, the temperature detection signal S_{DET} is generated based on the sum of the values ΔVF_cycle[1] to ΔVF_cycle[4]. That is to say, a value corresponding to the sum of the values ΔVF_cycle[1] to ΔVF_cycle[4] is set to be the digital value D_{DET} (referring to FIG. 3) which is the value of the temperature detection signal S_{DET}, and the detected value of the target temperature is represented by the digital value D_{DET}. In practice, the sum of the values ΔVF_cycle[1] to ΔVF_cycle[4] itself is set to be the digital value D_{DET}. However, a value that is K times the sum can also be set to be the digital value D_{DET} (K>1).

Herein, to provide more specific description, examples of specific values associated with the digital value of the ADC 22 are given below. At this point, the ADC 22 is set to be a 10-bit ADC. Thus, the digital signal S_{VF} has a value from 0 to 1023 as the digital value D_{VF}. Moreover, the temperature detection signal S_{DET} is also set to have a value from 0 to 1023 as the digital value D_{DET}.

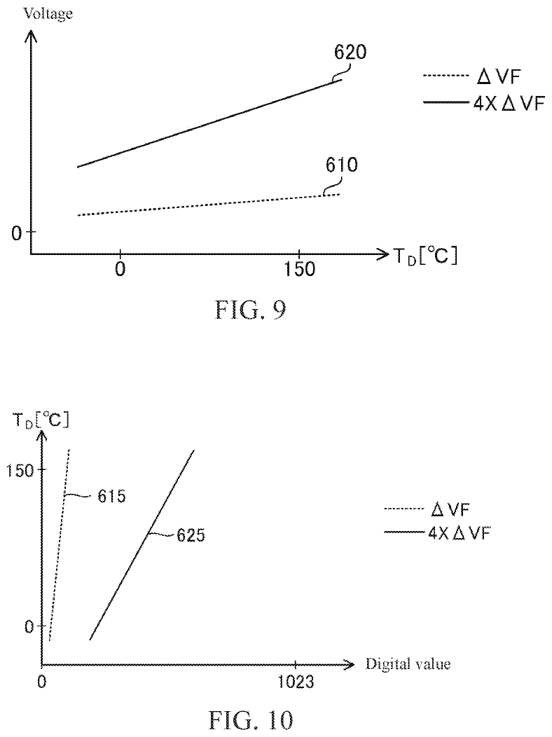

In FIG. 9, a dotted waveform 610 represents a relationship between an analog voltage value of the voltage ΔVF and the temperature T_{D}, and a solid waveform 620 represents a relationship between an analog voltage value of the voltage (4×ΔVF) and the temperature Tp. Since the voltage (4×ΔVF) is equivalent to four times the voltage ΔVF, the voltage (4×ΔVF), along with the change in the temperature T_{D}, changes across a value range much broader than the voltage ΔVF. Moreover, the amount of change (that is, a slope of the solid waveform 620) of the voltage (4×ΔVF) with respect to the amount of change per unit in the temperature T_{D} is four times the amount of change (that is, a slope of the dotted waveform 610) in the voltage ΔVF.

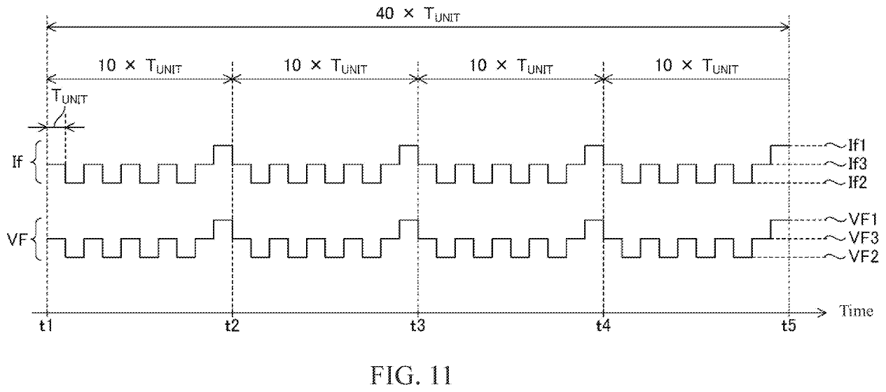

In FIG. 10, a dotted waveform 615 represents a relationship between a digital value of the ΔVF and the temperature T_{D}, and a solid waveform 625 represents a relationship between a digital value of the voltage (4×ΔVF) and the temperature T_{D}. The digital value of the voltage ΔVF has a value in a quite limited range (for example, a value from 0 to 100) within a dynamic range of a digital signal. In contrast, the digital value of the voltage (4×ΔVF) changes in a much broader range within the dynamic range compared to the digital value of the voltage ΔVF. Moreover, the amount of change in the digital value of the temperature T_{D} per ° C. becomes four times that of the voltage ΔVF in the voltage (4×ΔVF). This means that the resolution of the temperature T_{D} indicated by the digital value of the voltage (4×ΔVF) is four times compared to that of the voltage VF. For example, when the digital value of the voltage ΔVF presents the temperature T_{D} with a resolution of 2.4° C. per 1 least significant bit (LSB), the digital value of the voltage (4×ΔVF) presents the temperature T_{D} with a resolution of 0.6° C. per 1 LSB.

FIG. 11 shows a timing diagram of detection for a target temperature. The first round of cycle operation is performed from a timing t1 to a timing t2, a second round of cycle operation is performed from the timing t2 to a timing t3, a third round of cycle operation is performed from the timing t3 to a timing t4, and a fourth round of cycle operation is performed from the timing t4 to a timing t5. In each cycle operation, the temperature sensor 1 repeats performing the second unit detection process four times after the third unit detection process, and then performs the first unit detection process after the third unit detection process for the fifth time. Thus, in each cycle operation, one digital detected value D_{VF1}, four digital detected values D_{VF2} and five digital detected values D_{VF3} are obtained.

One unit of detection process needs a predetermined unit time T_{UNIT}. Thus, each cycle operation needs a period of time of (10×T_{UNIT}) minutes, and one round of detection for the target temperature needs a period of time of (40×T_{UNIT}) minutes. For example, the unit time T_{UNIT} is determined based on such as a stabilization time of the voltage VF and a sample/hold time of the ADC 22. When the forward current If is modified from a certain evaluation current to be another evaluation current, the voltage Vf fluctuates. The time needed for converging such fluctuation is a settling time of the voltage VF.

### Second Embodiment

The second embodiment is described. The specific values of the evaluation currents If1, If2 and If3 shown in the first embodiment are merely examples, and various modifications can be made. In the second embodiment, the techniques shown in the first embodiment are generalized using variables k1, k2, and k3. Each of the variables k1, k2 and k3 has an integer greater than or equal to 1.

In the temperature sensor 1 of the second embodiment, the evaluation currents If1, If2 and If3 are set to have formula (D1) below hold true. At this point, the voltage ΔV in the temperature sensor 1 can be defined as formula (D2) below. The significances of the voltages VF1, VF2 and VF3 are as shown in the first embodiment.

$$k 3 \times If 3 = k 1 \times If 1 + k 2 \times If 2 \qquad ( D1 )$$

$$ΔV F = k 3 \times V F3 - ( k 1 \times V F 1 + k 2 \times V F 2 ) \qquad ( D2 )$$

That is to say, formula (D3) can be obtained when formula (D2) is transformed using formulae (B1), (B2) and (B3). By setting both sides of formula (D3) to M times, formula (D4) can be obtained. M represents any integer greater than or equal to 2.

$$ΔV F = ( \frac{{K}_{B}}{q} ) \times {T}_{D} \times ln ( \frac{If {3}^{k 3}}{If {1}^{k 1} \times If {2}^{k 2}} ) \qquad ( D3 )$$

$$M \times ΔV F = M \times ( \frac{{K}_{B}}{q} ) \times {T}_{D} \times ln ( \frac{If {3}^{k 3}}{If {1}^{k 1} \times If {2}^{k 2}} ) \qquad ( D4 )$$

Thus, after the voltages VF1, VF2 and VF3 are detected, the value of the voltage ΔVF can be derived according to formula (D2), and the temperature T_{D} can be obtained using a derived result according to formula (D3). Formula (D3) does not include the term of the saturation current Is or the term of the resistive component R. Thus, the temperature T_{D} obtained according to formula (D3) does not receive influences of the deviation in the saturation current Is, and does not receive influences of the resistive component R. That is to say, high-precision temperature detection from which the influences above are eliminated can be performed.

The flowchart of an overall operation of the temperature sensor 1 according to the second embodiment is the same as that of the first embodiment (FIG. 6). The first embodiment is equivalent to the second embodiment in which it is set that (k1, k2, k3, M)=(1, 4, 5, 4).

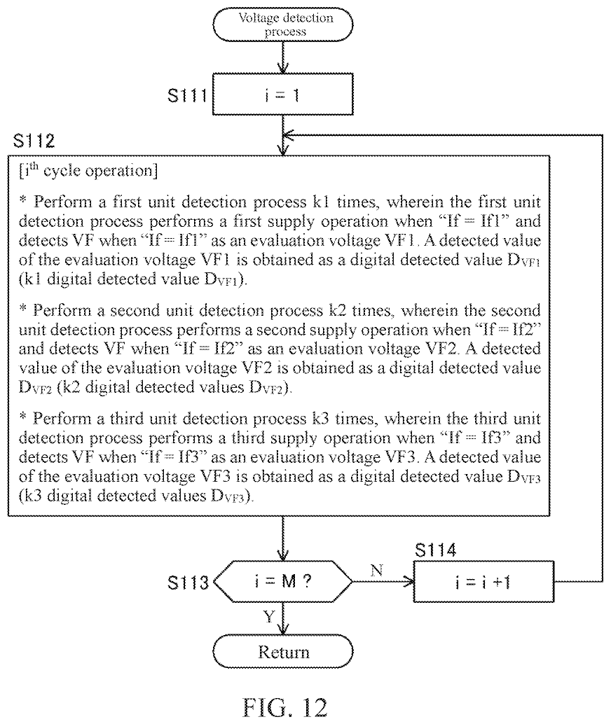

FIG. 12 shows a flowchart of the voltage detection process according to the second embodiment of the embodiments of the present disclosure. In the second embodiment, the voltage detection process of step S1 in FIG. 6 includes processes of step S111 to S114. In the voltage detection process, 1 is substituted into a variable i managed by the control circuit 40 itself in step S111. Step S112 is then performed.

In step S112, the temperature sensor 1 performs an i^{th} round of a cycle operation. In one round of cycle operation, the temperature sensor 1 performs the first unit detection process k1 times, performs the second unit detection process k2 times, and performs the third unit detection process k3 times. The cycle operation is performed by the current supply circuit 10 and the voltage detection circuit 20 under the control of the control circuit 40.

Details of the first, second and third unit detection processes are as those given in the description associated with the first embodiment. One digital detected value D_{VF1} representing the detected value of the evaluation voltage VF1 is obtained from the first unit detection process performed once. Thus, k1 digital detected values D_{VF1} are obtained in one round of cycle operation. One digital detected value D_{VF2} representing the detected value of the evaluation voltage VF2 is obtained from the second unit detection process performed once. Thus, k2 digital detected values D_{VF2} are obtained in one round of cycle operation. One digital detected value D_{VF3} representing the detected value of the evaluation voltage VF3 is obtained from the third unit detection process performed once. Thus, k3 digital detected values D_{VF3} are obtained in one round of cycle operation.

Step S113 is performed after step S112. In step S113, the control circuit 40 determines whether “i-M” holds true. When “i=M” holds true (“Yes” of step S113), the voltage detection process ends. When “i=M” does not hold true (“No” of step S113), 1 is added to the variable i by the control circuit 40 in step S114, and step S112 is iterated. Upon iterating step S112, the cycle operation is again performed. Thus, in a phase when the voltage detection process in FIG. 12 ends, the cycle operation of step S112 has been performed M times.

Moreover, in each cycle operation, given that the first unit detection process is performed k1 times, the second unit detection process is performed k2 times and the third unit detection process is performed k3 times, the orders for performing the first, second and third unit detection processes in each cycle operation can be any as desired.

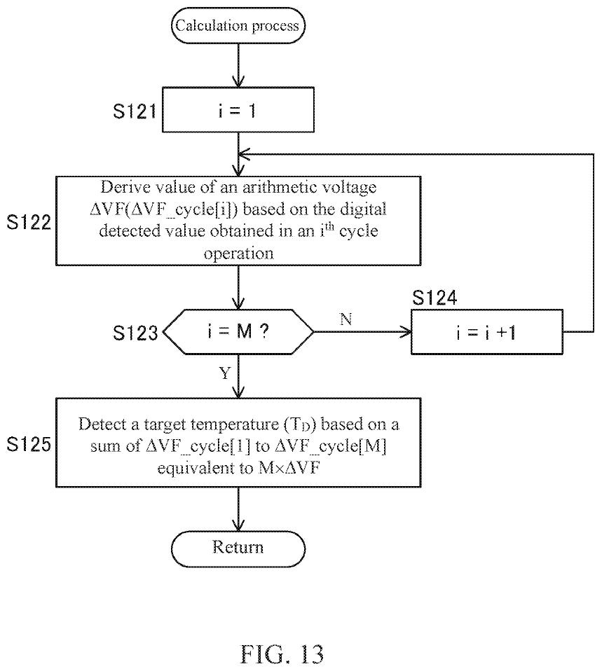

FIG. 13 shows a flowchart of the calculation process according to the second embodiment. In the second embodiment, the calculation process of step S2 in FIG. 6 includes processes of step S121 to S125. In the calculation process, 1 is substituted to a variable i managed by the arithmetic circuit 30 itself in step S121. Step S122 is then performed.

The process of step S122 is performed at any timing as desired after an i^{th} round of cycle operation ends. In step S122, the arithmetic circuit 30 derives the value of the arithmetic voltage ΔVF based on the digital detected value obtained in the i^{th} round of cycle operation according to formula (D2). With respect to the i^{th} round of cycle operation, the denotation “ΔVF_cycle[i]” represents the value of the arithmetic voltage ΔVF derived in step S121.

The digital detected value obtained in the i^{th} round of cycle operation includes k1 digital detected values D_{VF1}, k2 digital detected values D_{VF2}, and k3 digital detected values D_{VF3}. Thus, with respect to the i^{th} round of cycle operation, by substituting the k1 digital detected values D_{VF1} into the term (k1×VF1) of formula (D2), the k2 digital detected values D_{VF2} into the term (k2×VF2) of formula (D2), and the k3 digital detected values D_{VF3} into the term (k3×VF3) of formula (D2), the value on the left of formula (D2) can be calculated, and the value on the left calculated is set to be the value ΔVF_cycle[i].

Moreover, by substituting the k1 digital detected values D_{VF1} into the term (k1×VF1) of formula (D2) means that, if “k1≥2”, the sum of the k1 digital detected values D_{VF1} is substituted into the term (k1×VF1) of formula (D2). Similarly, by substituting the k2 digital detected values D_{VF2} into the term (k2×VF2) of formula (D2) means that, if “k2≥2”, the sum of the k2 digital detected values D_{VF2} is substituted into the term (k2×VF2) of formula (D2). Similarly, by substituting the k3 digital detected values D_{VF3} into the term (k3×VF3) of formula (D2) means that, if “k3≥2”, the sum of the k3 digital detected values D_{VF3} is substituted into the term (k3×VF3) of formula (D2).

Step S123 is performed after step S122. In step S123, the arithmetic circuit 30 determines whether “i=M” holds true. When “i-M” holds true (“Yes” of step S123), step S125 is performed. When “i=M” does not hold true (“No” of step S123), 1 is added to the variable i by the arithmetic circuit 30 in step S124, and step S122 is iterated. Upon iterating step S122, the process of step S122 is again performed. Thus, in a phase entering step S125, the values ΔVF_cycle[1] to ΔVF_cycle[M] have been derived.

In step S125, the arithmetic circuit 30 calculates a sum of the values ΔVF_cycle[1] to ΔVF_cycle[M]. The sum of the values ΔVF_cycle[1] to ΔVF_cycle[M] is equal to a voltage (M×ΔVF). Thus, in step S125, the arithmetic circuit 30 substitutes the sum of the values ΔVF_cycle[1] to ΔVF_cycle[M] to the left of formula (D4) to solve formula (D4) for the temperature T_{D}, accordingly detecting the target temperature (that is, the temperature T_{D}). However, the derivation of the target temperature (that is, the temperature T_{D}) using formula (D4) is not necessarily performed by the arithmetic circuit 30. With respect to the temperature sensor 1 (the arithmetic circuit 30), the values of the evaluation currents If1, If2 and If3, the Boltzmann constant K_{B}, and an amount of charge q of electrons are known.

In the arithmetic circuit 30, the temperature detection signal S_{DET} is generated based on the sum of the values ΔVF_cycle[1] to ΔVF_cycle[M]. That is to say, a value corresponding to the sum of the values ΔVF_cycle[1] to ΔVF_cycle[M] is set to be the digital value D_{DET} (referring to FIG. 3) which is the value of the temperature detection signal S_{DET}, and the detected value of the target temperature is represented by the digital value D_{DET}. In practice, the sum of the values ΔVF_cycle[1] to ΔVF_cycle[M] itself is set to be the digital value D_{DET}. However, a value that is K times the sum can also be set to be the digital value D_{DET} (K>1).

Provided that the voltage (M×ΔVF) can be derived, the order for the derivation is not limited to that of the steps above. That is to say, for example, in any order, (M×k1) digital detected values D_{VF1} are obtained by performing the first unit detection process (M×k1) times, (M×k2) digital detected values D_{VF2} are obtained by performing the second unit detection process (M×k2) times, and (M×k3) digital detected values D_{VF3} are obtained by performing the third unit detection process (M×k3) times. Next, instead of deriving the values ΔVF_cycle[1] to ΔVF_cycle[M] one after another, the voltage (M×ΔVF) equivalent to the sum of the voltages ΔVF_cycle[1] to ΔVF_cycle[M] is directly derived based on the (M×k1) digital detected values D_{VF1}, the (M×k2) digital detected values D_{VF2} and the (M×k3) digital detected values D_{VF3}.

### Third Embodiment

The third embodiment is described. As shown in the second embodiment, the number of the cycle operation performed (that is, the value of M) can be any value of greater than or equal to 2 as desired. By appropriately setting the number of times of the cycle operation performed, the relationship between the temperature detection signal S_{DET} and the digital value D_{DET} can be set as desired.

However, the number of times of the cycle operation performed can also be set as 1. That is to say, it can be set that “M=1”. When “M=1”, only the value ΔVF_cycle[1] is derived in step S122 of the calculation process, and the arithmetic circuit 30 in step S125 substitutes the value ΔVF_cycle[1] to the left of formula (D3) to solve formula (D3) for the temperature T_{D}, accordingly detecting the target temperature (that is, the temperature T_{D}). In step S125, the temperature detection signal S_{DET} is generated based on the value ΔVF_cycle[1]. That is to say, a value corresponding to the value ΔVF_cycle[1] is set to be the digital value D_{DET} (referring to FIG. 3) which is the value of the temperature detection signal S_{DET}, and the detected value of the target temperature is represented by the digital value D_{DET}. In practice, the value ΔVF_cycle[1] itself can also be set to be the digital value D_{DET}. However, a value that is K times the value ΔVF_cycle[1] can also be set to be the digital value D_{DET} (K>1).

### Fourth Embodiment

The fourth embodiment is described. When the variable k1 is 2 or more, in the second embodiment, a basic method below is implemented in order to calculate the value on the left of formula (D2). In the basic method, k1 digital detected values D_{VF1} are obtained by performing the first unit detection process k1 times in one round of cycle operation, and a sum of the k1 digital detected values D_{VF1} is substituted into the term (k1×VF1) of formula (D2). When the variable k1 is 2 or more, a first or second variation method below can also be used in substitution for the basic method.

In the first variation method, the first unit detection is performed only once in one round of cycle operation to obtain one digital detected value D_{VF1}, and the one digital detected value D_{VF1} is set to be k1 times by the arithmetic circuit 30. Then, the arithmetic circuit 30 in the first variation method substitutes the digital detected value D_{VF1} that is k1 times into the term (k1×VF1) of formula (D2). If the first variation method is used, the time needed for detecting the target temperature is shorter than that of the basic method. On the other hand, in the first variation method, various noises generated by front-end circuits of the arithmetic circuit 30 are also to set to be k1 times during the calculation process of k1 times in the arithmetic circuit 30. Thus, from the perspective of a signal-to-noise ratio (SNR), the basic method is more advantageous.

In the second variation method, the first unit detection is performed only once in one round of cycle operation to obtain one digital detected value D_{VF1}, and at this point, an amplification operation is performed by the amplifier 21 so that k1 times the voltage VF when “If=If1” becomes the input analog voltage to the ADC 22. Thus, in the second variation method, by obtaining the digital detected value D_{VF1} by AD converting the k1 times of the voltage VF in a period while “If=If1”, the digital detected value D_{VF1} represents k1 times of the detected value of the evaluation voltage VF1. Thus, the arithmetic circuit 30 in the second variation method substitutes the obtained digital detected value D_{VF1} itself into the term (k1×VF1) of formula (D2). If the second variation method is used, the time needed for detecting the target temperature is shorter than that of the basic method. On the other hand, in the second variation method, during the amplification operation of the amplifier 21, various noises generated are also set to be k1 times. Thus, from the perspective of an SNR, the basic method is more advantageous.

To make the description more specific, the first and second variation methods are explained focusing on the first unit detection process, the digital detected value D_{VF1} and the term (k1×VF1). However, when the first variation method is applied for the first unit detection process, the digital detected value D_{VF1} and the term (k1×VF1), the first variation method is also applied to the second unit detection process, the digital detected value D_{VF2} and the term (k2×VF2), and first variation method is also applied to the third unit detection process, the digital detected value D_{VF3} and the term (k3×VF3). Similarly, when the second variation method is applied for the first unit detection process, the digital detected value D_{VF1} and the term (k1×VF1), the second variation method is also applied to the second unit detection process, the digital detected value D_{VF2} and the term (k2×VF2), and second variation method is also applied to the third unit detection process, the digital detected value D_{VF3} and the term (k3×VF3).

For example, when the first variation method is applied to the second unit detection process, the digital detected value D_{VF2} and the term (k2×VF2), one digital detected value D_{VF2} is obtained by performing the second unit detection process once in one round of the cycle operation, and the one digital detected value D_{VF2} is set to be k2 times by the arithmetic circuit 30. Then, the arithmetic circuit 30 substitutes the digital detected value D_{VF2} that is k2 times into the term (k2×VF2) of formula (D2).

### Fifth Embodiment

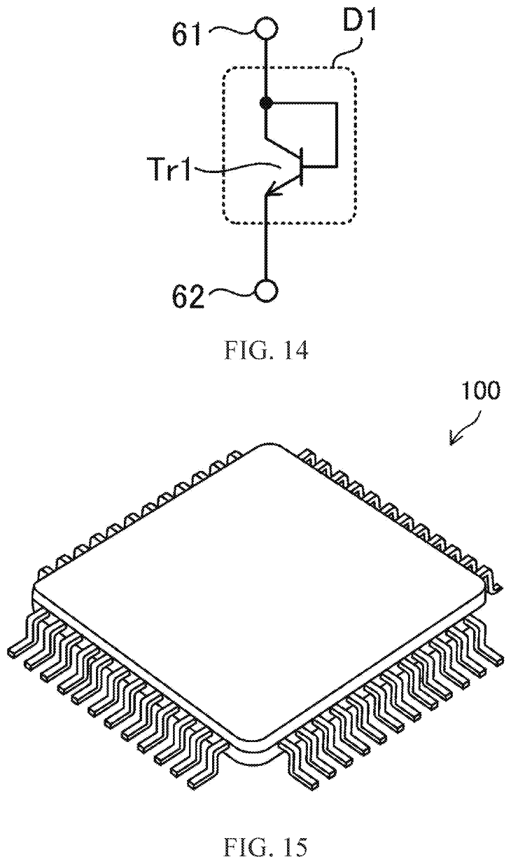

The fifth embodiment is described. The diode D1 can be formed by a bipolar transistor. That is to say, as shown in FIG. 14, a transistor Tr1 which is an NPN bipolar transistor can be used as the diode D1. In this case, in the transistor Tr1, a collector and a base are connected to each other, the collector functions as an anode of the diode D1 and is connected to the node 61, and an emitter functions as a cathode of the diode D1 and is connected to the node 62.

However, as described with reference to FIG. 4, the resistive component R can exist between the node 61 and the collector of the transistor Tr1. Or, as described with reference to FIG. 5, the resistive component R can exist between the node 62 and the emitter of the transistor Tr1. There can be a case where a resistive component R exists individually between the node 61 and the collector of the transistor Tr1, and between the node 62 and the emitter of the transistor Tr1.

Moreover, in substitution for an NPN bipolar transistor, the diode D1 can also be formed by a PNP bipolar transistor.

### Sixth Embodiment

The sixth embodiment is described. First to third diodes can be provided in advance in the temperature sensor 1, and the first to third diodes are used as the diode D1 to detect a target temperature.

In this case, the first to third diodes are disposed at positions having a common target temperature. Moreover, during a period in which the evaluation current If1 is supplied to the first diode as a forward current of the first diode, the voltage detection circuit 20 is caused to detect the voltage VF of the first diode as the evaluation voltage VF1. Similarly, during a period in which the evaluation current If2 is supplied to the second diode as a forward current of the second diode, the voltage detection circuit 20 is caused to detect the voltage VF of the second diode as the evaluation voltage VF2. Similarly, during a period in which the evaluation current If3 is supplied to the third diode as a forward current of the third diode, the voltage detection circuit 20 is caused to detect the voltage VF of the third diode as the evaluation voltage VF3. The voltage VF of the first, second and third diodes is each defined as the voltage VF of the diode D1.

The first to third diodes are configured to have the same structure and hence have the same electrical characteristics. However, in practice, the structures and electrical characteristics of the diodes can be deviated among the first to third diodes, and the deviations thereof appear as detection deviations of the target temperature. Moreover, a circuit area is increased by the amount needed for disposing the three diodes. Thus, a configuration using one single diode is preferably used (the configuration in FIG. 3).

### Seventh Embodiment

The seventh embodiment is described.

Strictly speaking, there is an ideal coefficient n in a diode equation, and the following formula holds true if the ideal coefficient is taken into consideration.

$$k 3 \times V F 3 - ( k 1 \times V F 1 + k 2 \times V F 2 ) = n \times ( \frac{{K}_{B}}{q} ) \times {T}_{D} \times ln ( \frac{If {3}^{k 3}}{If {1}^{k 1} \times If {2}^{k 2}} )$$

The ideal coefficient n has a value of substantially “1”. If the ideal coefficient n is completely consistent with 1 or fully close to 1, the presence of the ideal coefficient n can be overlooked. Assuming that if a difference (n−1) cannot be overlooked, the relationship between the temperature T_{D} and the digital value VDET is slightly adjusted by actual testing and evaluation as appropriate.

The node 62 can have a potential other than the ground potential. The potential independent from the node 62 is consistent/inconsistent with the ground potential, and the voltage detection circuit 20 only needs to detect a potential at the node 61 (that is, the voltage VF) viewed from the potential at the node 62.

The current supply circuit 10 supplies n types evaluation currents to the diode D1 at different timings as the forward current If of the diode D1. In the temperature sensor 1 in FIG. 3, “n=3”, and the n types of evaluation currents are the evaluation currents If1, If2 and If3. However, n can also have an integer value of 4 or more. In this case, for each of the cases where “i=1”, “i=2”, “i=3”, . . . and “i=n”, the voltage detection circuit 20 performs an operation of detecting the voltage VF when the i^{th} evaluation current is supplied to the target path 60 as the first evaluation voltage. Moreover, the arithmetic circuit 30 can also detect the target temperature based on the first evaluation voltage to the n^{th} evaluation voltage.

The temperature sensor 1 can be assembled in any semiconductor device as desired. FIG. 15 shows a perspective diagram of an appearance of a semiconductor device 100 assembled with the temperature sensor 1. The semiconductor device 100 is an electronic component including a semiconductor chip having a semiconductor integrated circuit formed on a semiconductor substrate, a housing (a package) accommodating the semiconductor chip, and a plurality of external terminals exposed from the housing to the outside of the semiconductor device 100. The semiconductor device 100 is formed by packaging the semiconductor chip in the housing (the package) formed of a resin. Moreover, the number of the external terminals of the semiconductor device 100 and the type of the housing of the semiconductor device 100 shown in FIG. 15 are merely examples, and can be designed as desired. The semiconductor integrated circuit in the semiconductor device 100 further includes various functional circuits in addition to including the temperature sensor 1. The functional circuits are, for example, DC/DC converts and motor drivers.

The position of the temperature to be detected is referred to as a target position. The target temperature is a temperature of the target position. Any position (for example, a central position) of the semiconductor device 100 is set as the target position. In the semiconductor device 100, a plurality of positions can also be set as target positions. In this case, the temperature sensor 1 can be disposed according to each of the target positions. The diode D1 can also be disposed according to each of the target positions. On the other hand, by commonly assigning a detection block including the voltage detection circuit 20 and the arithmetic circuit 30 to a plurality of diodes D1 and switching an input signal to the buffer amplifier 21 by a selector, one single detection block can be used for detection for a plurality of target temperatures.

The types of the channels of the field-effect transistors (FETs) shown in the embodiments are examples. Without compromising the form of the subject, any variation between P-type channels and N-type channels can be made.

Given that no issues are incurred, any transistor may also be any type of transistor. For example, given that no issues are incurred, any transistor implemented by a MOSFET may be replaced by a junction FET or a bipolar transistor.

Various modifications may be appropriately made to the embodiments of the present disclosure within the scope of the technical concept of the claims. The embodiments above are only examples of possible implementations of the present disclosure, and the meanings of the terms of the present disclosure or the constituents are not limited to the meanings of the terms used in the embodiments above. The specific numerical values used in the description are only examples, and these numerical values may be modified to various other numerical values.

### <<Notes>>

A note is attached to the present disclosure to show specific configuration examples of the embodiments above.

A temperature sensor according to an aspect of the present disclosure is configured as (a first configuration), comprising:
a temperature detection diode (D1), disposed at a position having a target temperature (T_{D}) and inserted into a target path (60) between a first node and a second node;
a current supply circuit (10), configured to supply a first evaluation current (If1), a second evaluation current (If2) and a third evaluation current (If3) to the target path in a forward direction of the temperature detection diode at different timings;
a voltage detection circuit (20), configured to detect a voltage (VF) between the first node and the second node when the first evaluation current, the second evaluation current and the third evaluation current are respectively supplied to the target path as a first evaluation voltage (VF1), a second evaluation voltage (VF2) and a third evaluation voltage (VF3); and
an arithmetic circuit (30), configured to detect the target temperature based on the first evaluation voltage, the second evaluation voltage and the third evaluation voltage.

Accordingly, temperature detection can be well performed. More specifically, temperature detection suppressing influences associated with a deviation in a saturation current of the diode can be performed. Moreover, even if when the target path includes a resistive component, by using the three evaluation currents, temperature detection can be performed while influences of the resistive component are suppressed.

The temperature sensor of the first configuration can also be configured as (a second configuration), wherein the arithmetic circuit is configured to detect the target temperature by adding or subtracting the first evaluation voltage, the second evaluation voltage and the third evaluation voltage according to a predetermined calculation formula based on a relationship among the first evaluation current, the second evaluation current and the third evaluation current.

The temperature sensor of the second configuration can also be configured as (a third configuration), wherein
each of the first evaluation current, the second evaluation current and the third evaluation current is set to satisfy formula (1),
the calculation formula is formula (2),
the arithmetic circuit is configured to
   derive ΔVF according to formula (2), and
   generate a temperature detection signal according to a derivation result of ΔVF,
If1, If2 and If3 represent the first, second, and third evaluation currents, respectively,
VF1, VF2 and VF3 represent the first, second, and third evaluation voltages, respectively, and
each of k1, k2 and k3 represents an integer greater than or equal to 1.

$$k 3 \times If 3 = k 1 \times If 1 + k 2 \times If 2 \qquad ( 1 )$$

$$ΔV F = k 3 \times V F 3 - ( k 1 \times V F 1 + k 2 \times V F 2 ) \qquad ( 2 )$$

The temperature sensor of the third configuration can also be configured as (a fourth configuration), wherein
the current supply circuit is configured to
   perform a first supply operation of supplying the first evaluation current to the temperature detection diode k1 times,
   perform a second supply operation of supplying the second evaluation current to the temperature detection diode k2 times, and
   perform a third supply operation of supplying the third evaluation current to the temperature detection diode k3 times,
the voltage detection circuit is configured to
   obtain k1 detected values (D_{VF1}) of the first evaluation voltage by detecting the first evaluation voltage each time upon the first supply operation,
   obtain k2 detected values (D_{VF2}) of the second evaluation voltage by detecting the second evaluation voltage each time upon the second supply operation, and
   obtain k3 detected values (D_{VF3}) of the third evaluation voltage by detecting the third evaluation voltage every time upon the third supply operation, and
the arithmetic circuit is configured to derive ΔVF using k1 detected values for the first evaluation voltage, k2 detected values for the second evaluation voltage and k3 detected values for the third evaluation voltage based on formula (2).

The temperature sensor of the fourth configuration can also be configured as (a fifth configuration), wherein
ΔVF satisfies formula (3),

$$ΔV F = ( \frac{{K}_{B}}{q} ) \times {T}_{D} \times ln ( \frac{If {3}^{k 3}}{If {1}^{k 1} \times If {2}^{k 2}} ) \qquad ( 3 )$$

the operation voltage derived based on formula (2) is substituted to the left of formula (3), K_{B} represents the Boltzmann constant, q represents an amount of charge of electrons, T_{D} represents the target temperature, and

$$ln ( \frac{If {3}^{k 3}}{If {1}^{k 1} \times If {2}^{k 2}} )$$

represents a natural logarithm of

$$( \frac{If {3}^{k 3}}{If {1}^{k 1} \times If {2}^{k 2}} ) .$$

The temperature sensor of the fourth or fifth configuration can also be configured as (a sixth configuration), wherein
the current supply circuit is configured to
   perform a first supply operation of supplying the first evaluation current to the temperature detection diode (M×k1) times,
   perform a second supply operation of supplying the second evaluation current to the temperature detection diode (M×k2) times, and
   perform a third supply operation of supplying the third evaluation current to the temperature detection diode (M×k3) times,
the voltage detection circuit is configured to
   obtain (M×k1) detected values of the first evaluation voltage by detecting the first evaluation voltage each time the first supply operation is performed,
   obtain (M×k2) detected values of the second evaluation voltage by detecting the second evaluation voltage each time the second supply operation is performed, and
   obtain (M×k3) detected values of the third evaluation voltage by detecting the third evaluation voltage each time the third supply operation is performed, and
the arithmetic circuit is configured to
   derive (M×ΔVF) using (M×k1) detected values for the first evaluation voltage, (M×k2) detected values for the second evaluation voltage and (M×k3) detected values for the third evaluation voltage based on formula (2), and
   generate the temperature detection signal according to a derivation result of (M×ΔVF), in which M represents an integer greater than or equal to 2.

By generating the temperature detection signals using a group of detected values sufficient for deriving M times of ΔVF, the detection resolution can be improved.

The temperature sensor of any one of the first to sixth configurations can also be configured as (a seventh configuration), wherein
the voltage detection circuit includes an A/D converter (22),
the A/D converter is configured to, by analog/digital converting the voltage between the first node and the second node when the first evaluation current, the second evaluation current and the third evaluation current are supplied to the temperature detection diode, generate a first digital detected value, a second digital detected value and a third digital detected value respectively representing detected values of the first evaluation voltage (D_{VF1}), the second evaluation voltage (D_{VF2}) and the third evaluation voltage (D_{VF3}), and
the arithmetic circuit is configured to detect the target temperature based on the first digital detected value, the second digital detected value and the third digital detected value.

The temperature sensor of the first or second configuration can also be configured as (an eighth configuration), wherein the arithmetic circuit is configured to generate a temperature detection signal (S_{DET}) indicating a detection result of the target temperature.

The temperature sensor of any one of the first to eighth configurations can also be configured as (a ninth configuration), wherein the target path includes a resistive component (R), and each of the first evaluation current, the second evaluation current and the third evaluation current passes through the temperature detection diode and the resistive component.

The temperature sensor of any one of the first to ninth configurations can also be configured as (a tenth configuration), wherein the temperature detection diode is formed by a bipolar transistor having a collector and a base connected to the collector.

The temperature sensor of any one of the first to fourth configurations can also be configured as (a fifth configuration), wherein the temperature detection circuit is configured to generate a temperature detection signal indicating a detection result of the target temperature.

The temperature sensor of any one of the first to fifth configurations can also be configured as (a sixth configuration), wherein each of the temperature detection diode and the reference diode is formed by a bipolar transistor having a collector and a base connected to the collector.

1. A temperature sensor, comprising:
a temperature detection diode, disposed at a position having a target temperature and inserted into a target path between a first node and a second node;
a current supply circuit, configured to supply a first evaluation current, a second evaluation current and a third evaluation current to the target path in a forward direction of the temperature detection diode at different timings;
a voltage detection circuit, configured to detect a voltage between the first node and the second node when the first evaluation current, the second evaluation current and the third evaluation current are respectively supplied to the target path as a first evaluation voltage, a second evaluation voltage and a third evaluation voltage; and
an arithmetic circuit, configured to detect the target temperature based on the first evaluation voltage, the second evaluation voltage and the third evaluation voltage.

2. The temperature sensor of claim 1, wherein the arithmetic circuit is configured to detect the target temperature by adding or subtracting the first evaluation voltage, the second evaluation voltage and the third evaluation voltage according to a predetermined calculation formula based on a relationship among the first evaluation current, the second evaluation current and the third evaluation current.

3. The temperature sensor of claim 2, wherein
each of the first evaluation current, the second evaluation current and the third evaluation current is set to satisfy formula (1),
the calculation formula is formula (2),
the arithmetic circuit is configured to
derive ΔVF according to formula (2), and
generate a temperature detection signal according to a derivation result of ΔVF, If1, If2, If3 represent the first, second, and third evaluation currents, respectively, VF1, VF2, and VF3 represent the first, second, and third evaluation voltages, respectively,
each of k1, k2 and k3 represents an integer equal to or greater than 1, and
$$k 3 \times If 3 = k 1 \times If 1 + k 2 \times If 2 \qquad ( 1 )$$
$$ΔV F = k 3 \times V F 3 - ( k 1 \times V F 1 + k 2 \times V F 2 ) . \qquad ( 2 )$$

4. The temperature sensor of claim 3, wherein
the current supply circuit is configured to perform a first supply operation of supplying the first evaluation current to the temperature detection diode k1 times,
perform a second supply operation of supplying the second evaluation current to the temperature detection diode k2 times, and
perform a third supply operation of supplying the third evaluation current to the temperature detection diode k3 times,
the voltage detection circuit is configured to
obtain k1 detected values of the first evaluation voltage by detecting the first evaluation voltage each time upon the first supply operation,
obtain k2 detected values of the second evaluation voltage by detecting the second evaluation voltage each time upon the second supply operation, and
obtain k3 detected values of the third evaluation voltage by detecting the third evaluation voltage every time upon the third supply operation, and
the arithmetic circuit is configured to derive ΔVF using k1 detected values for the first evaluation voltage, k2 detected values for the second evaluation voltage and k3 detected values for the third evaluation voltage based on formula (2).

5. The temperature sensor of claim 4, wherein
ΔVF satisfies formula (3),
$$ΔV F = ( \frac{{K}_{B}}{q} ) \times {T}_{D} \times ln ( \frac{If {3}^{k 3}}{If {1}^{k 1} \times If {2}^{k 2}} ) \qquad ( 3 )$$
K_{B} represents Boltzmann constant, q represents amount of charge of electrons, T_{D} represents the target temperature, and
$$ln ( \frac{If {3}^{k 3}}{If {1}^{k 1} \times If {2}^{k 2}} )$$
represents natural logarithm of
$$( \frac{If {3}^{k 3}}{If {1}^{k 1} \times If {2}^{k 2}} ) .$$

6. The temperature sensor of claim 3, wherein
the current supply circuit is configured to
perform a first supply operation of supplying the first evaluation current to the temperature detection diode (M×k1) times,
perform a second supply operation of supplying the second evaluation current to the temperature detection diode (M×k2) times, and
perform a third supply operation of supplying the third evaluation current to the temperature detection diode (M×k3) times,
the voltage detection circuit is configured to
obtain (M×k1) detected values of the first evaluation voltage by detecting the first evaluation voltage each time the first supply operation is performed,
obtain (M×k2) detected values of the second evaluation voltage by detecting the second evaluation voltage each time the second supply operation is performed, and
obtain (M×k3) detected values of the third evaluation voltage by detecting the third evaluation voltage each time the third supply operation is performed, and
the arithmetic circuit is configured to
derive (M×ΔVF) using (M×k1) detected values for the first evaluation voltage, (M×k2) detected values for the second evaluation voltage and (M×k3) detected values for the third evaluation voltage based on formula (2), and
generate the temperature detection signal according to a derivation result of (M×ΔVF), in which M represents an integer equal to or greater than 2.

7. The temperature sensor of claim 1, wherein
the current detection circuit includes an A/D converter,
the A/D converter is configured to, by analog/digital converting the voltage between the first node and the second node when the first evaluation current, the second evaluation current and the third evaluation current are supplied to the temperature detection diode, generate a first digital detection value, a second digital detection value and a third digital detection value respectively representing detected values of the first evaluation voltage, the second evaluation voltage and the third evaluation voltage, and
the arithmetic circuit is configured to detect the target temperature based on the first digital detection value, the second digital detection value and the third digital detection value.

8. The temperature sensor of claim 2, wherein
the current detection circuit includes an A/D converter,
the A/D converter is configured to, by analog/digital converting the voltage between the first node and the second node when the first evaluation current, the second evaluation current and the third evaluation current are supplied to the temperature detection diode, generate a first digital detection value, a second digital detection value and a third digital detection value respectively representing detected values of the first evaluation voltage, the second evaluation voltage and the third evaluation voltage, and
the arithmetic circuit is configured to detect the target temperature based on the first digital detection value, the second digital detection value and the third digital detection value.

9. The temperature sensor of claim 3, wherein
the current detection circuit includes an A/D converter,
the A/D converter is configured to, by analog/digital converting the voltage between the first node and the second node when the first evaluation current, the second evaluation current and the third evaluation current are supplied to the temperature detection diode, generate a first digital detection value, a second digital detection value and a third digital detection value respectively representing detected values of the first evaluation voltage, the second evaluation voltage and the third evaluation voltage, and
the arithmetic circuit is configured to detect the target temperature based on the first digital detection value, the second digital detection value and the third digital detection value.

10. The temperature sensor of claim 4, wherein
the current detection circuit includes an A/D converter,
the A/D converter is configured to, by analog/digital converting the voltage between the first node and the second node when the first evaluation current, the second evaluation current and the third evaluation current are supplied to the temperature detection diode, generate a first digital detection value, a second digital detection value and a third digital detection value respectively representing detected values of the first evaluation voltage, the second evaluation voltage and the third evaluation voltage, and
the arithmetic circuit is configured to detect the target temperature based on the first digital detection value, the second digital detection value and the third digital detection value.

11. The temperature sensor of claim 1, wherein the arithmetic circuit is configured to generate a temperature detection signal indicating a detection result of the target temperature.

12. The temperature sensor of claim 2, wherein the arithmetic circuit is configured to generate a temperature detection signal indicating a detection result of the target temperature.

13. The temperature sensor of claim 1, wherein
the target path includes a resistive component, and
each of the first evaluation current, the second evaluation current and the third evaluation current passes through the temperature detection diode and the resistive component.

14. The temperature sensor of claim 2, wherein
the target path includes a resistive component, and
each of the first evaluation current, the second evaluation current and the third evaluation current passes through the temperature detection diode and the resistive component.

15. The temperature sensor of claim 3, wherein
the target path includes a resistive component, and
each of the first evaluation current, the second evaluation current and the third evaluation current passes through the temperature detection diode and the resistive component.

16. The temperature sensor of claim 4, wherein
the target path includes a resistive component, and
each of the first evaluation current, the second evaluation current and the third evaluation current passes through the temperature detection diode and the resistive component.

17. The temperature sensor of claim 1, wherein the temperature detection diode is formed by a bipolar transistor having a collector and a base connected to the collector.

18. The temperature sensor of claim 2, wherein the temperature detection diode is formed by a bipolar transistor having a collector and a base connected to the collector.

19. The temperature sensor of claim 3, wherein the temperature detection diode is formed by a bipolar transistor having a collector and a base connected to the collector.

20. The temperature sensor of claim 4, wherein the temperature detection diode is formed by a bipolar transistor having a collector and a base connected to the collector.
